(19) United States
(12) Patent Application Publication
(10) Pub. No.: US 2002/0107931 A1
(43) Pub. Date: Aug. 8, 2002

(54) Multi-way interactive email performing functions of networks and the web

(75) Inventors: Kul Singh, New York, NY (US); Richard A. Scott, Bethlehem, PA (US)

Correspondence Address: Steven R. Greenfield, Esq., Jenkens & Gilchrist, P.C., 3200 Fountain Place, 1445 Ross Avenue, Dallas, TX, 75202-2799, US

(73) Assignee: ServZone.Com, Inc.

(21) Appl. No.: 10/072,445

(22) Filed: Feb. 7, 2002

Related U.S. Application Data
(60) Provisional application No. 60/267,117, filed on Feb. 7, 2001.

(51) Int. Cl. G06F 15/16

(52) U.S. Cl. 709/206

(57) ABSTRACT

An improved system that enables interactive networks to be configured and delivered to HTML enabled email systems providing common access to applications and data between two or more parties. The system also provides the capability to link interactive components within the email that, upon execution, dynamically affect the content of the email. The system permits the construction and delivery of dynamic network content enabling email to serve as an ad-hoc, impromptu intranet or extranet. The system internally manages the identification of each node of the email network and creates and tracks security authorization and entitlements ensuring that only authenticated recipients see authorized information. The system combines robust networking capability with two-way interactivity, creating efficiencies for the purposes of information sharing, collaboration, customer relationship management, and online marketing. Anytime the recipient either re-opens the email or refreshes it, the body of the email will reflect the latest transmitted data. The system creates a private and secure network when enterprises or individual users email one or more recipients.

### BACKGROUND OF THE INVENTION

1. Technical Field of the Invention

This invention relates in general to Internet communications via email, and, more particularly, to the transmittal of real-time proprietary information for the purposes of customer relationship management, online marketing, information sharing, and collaboration.

2. Description of the Related Art

Static information and messages are already shared among Internet users via email. Intranets and extranets provide a secure and private network that operates like the Internet but access is restricted to a limited group of authorized users (as employees of a company), or to a group of users not requiring active authentication. Intranets and extranets also operate around a predetermined group of pre-registered users in a fixed network environment.

Existing email technology enables users to purchase goods or view streaming video and audio directly from within an email. The technology allows recipients to play, pause, or stop a streaming message that is embedded within the email. This technology generally requires an applet to be downloaded to the recipient's PC. This technology does not modify the message within the email based on a recipient's input nor is the email linked to a network that can transmit real-time information and data. Each time the email is re-opened, the email will always contain the same message, content, or data.

Networks such as intranets and extranets operate around a predetermined group of pre-registered users in a fixed network environment where access is restricted to a limited group of authorized users (such as employees of a company). Additionally when users need to access information over the Internet, a Web browser is generally used. The Web browser works by transmitting large amounts of data and Web pages each time a user visits a URL.

There are many difficulties with the present techniques for updating information for email users. Enterprises and individuals utilize email on a day-to-day basis for many purposes. At this time, a new email must be sent to a user each time the originator wants to provide updates or information to the intended recipient. This can be time-consuming and also creates unnecessary emails to be sent back and forth. Emails can strain an enterprise's server capacity, especially when large files are transmitted. As the number of users on the Internet increase and the number of emails for personal and commercial purposes increase, this can become a strain on the entire Internet system. The existing email technology fails to account for these issues for the purposes of customer relationship management, online marketing, information sharing, and collaboration.

Intranets and extranets currently are created to enable users to share proprietary information in a secure and private network. Yet, often there is a need to share real-time proprietary information outside of this pre-determined network. In this case, the only solution is email, which currently does not function as a network and currently only provides a one-way static tool to send information.

Presently in addition to the shortcomings in email, the experience of the Web is similar to reading a book as opposed to true dynamic two-way interactivity. The Web causes a strain on networks and servers because large amounts of data and Web pages are required to be transmitted across servers, as opposed to the data that is specifically requested or required by the user.

In order to create a virtual network, users must take the time to download an application to their personal computer, which takes time and effort. In addition, in order for a user to interact with someone within a virtual network, it is necessary for that user to download the application to a personal computer. This is not efficient or realistic for communication that needs to occur with customers or suppliers. Thus, though the virtual networks that currently exist are well suited to enhance existing internal networks, they fail to eliminate the issues of flexible network requirements that need to reach beyond the enterprise.

The challenge is therefore to create a system that would eliminate these drawbacks.

### SUMMARY OF THE INVENTION

The solution to these drawbacks is to create an email system that performs the complex functions of a network or an Intranet, providing network connectivity and interactivity directly to a computer user's inbox. In addition the solution would need to enable the user or enterprise to easily create such an email without much more effort than an email is currently created. This is a sizable undertaking, requiring integration with a company's existing networking and email infrastructure or technology that provides a platform that makes it easy for users to create such an email.

Embodiments of the present invention allow users to create ad-hoc, on-demand intranets and extranets via email, which provides a flexible, virtual network to share proprietary or non-proprietary information. The system enables the email to access the Internet directly without the requirement of a Web browser. Even without access of a web browser, an exemplary email will be live and dynamic as opposed to static. An exemplary email can reflect changing content. The system also allows users to make inputs into the email, which will update and change the body of the email message depending upon the inputs.

### BRIEF DESCRIPTION OF THE DRAWINGS

FIG. 1 depicts and exemplary email architecture in accordance with an embodiment of the present invention;

FIGS. 2 and 3 illustrate an exemplary email that is refreshed by the originator after being emailed in accordance with the present invention; and

FIGS. 4 and 5 illustrate an exemplary email that interacts with the user at the email destination and refreshes in response to user input.

### DETAILED DESCRIPTION OF THE PRESENT INVENTION

In accordance with the principles of the invention, a system that enhances email with network interactivity, embedded Internet processes and functionality, and two-way interactivity is provided. This system creates a unique network ID for each virtual network and a sub-network ID for each user within the network. This two-identifier approach permits for grouping people and sharing information across the network while retaining the ability to communicate and collect information from individuals on the email network. When an email originator uses the system, the technology automatically assigns a unique and randomized network ID. This is the network ID for that originator and for each recipient that the email is sent to by the originator or forwarded by a recipient. Each recipient within the network also is assigned a sub-network ID that uniquely identifies each user (email recipient) of the network. This effectively creates a network among all email recipients and the originator.

All users within this network ID have access to shared real-time information that is transmitted from a private network or intranet. The system also provides a way of accessing the Internet through the use of server-side executables programs as opposed to the exchange of static Web pages. The recipient does not require a Web browser since they can access the Internet directly from within the email. This technology enables users to easily embed a proprietary refreshable Internet page or document into the body of an email. Each time an email recipient opens the email the content within the Web Window is automatically refreshed, ensuring the timeliest information.

The system enables two-way interactivity through the use of network-ID linked variables that link applications in an email with applications in a private network transmitted via the Internet into the body of the email. The system enables email to incorporate one or more applications, and based on the applications selected will determine whether the email is useful for customer relationship management, online marketing, information sharing, or collaboration.

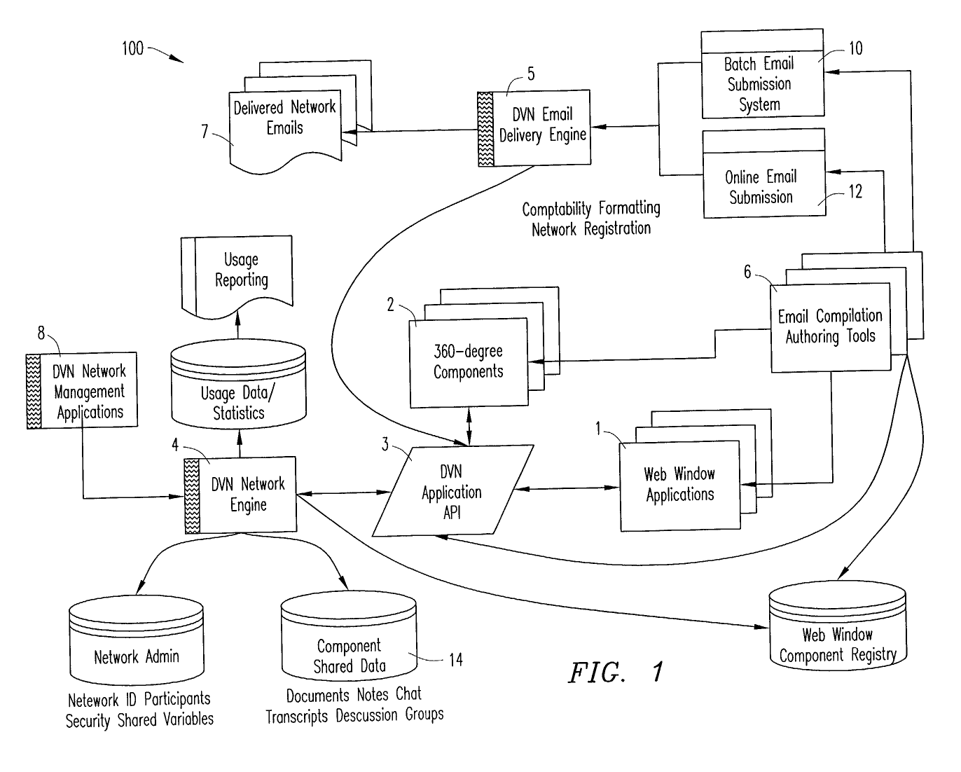

FIG. 1 shows the process relationships between the logical software components of the exemplary network email system 100. Email applications (Web Windows) 1 and embedded interactive components (360-degree components) 2 retrieve and share critical network information through the use of the DVN Application API 3 that in turn communicates with the DVN Network engine 4. The DVN Application API 3 uses Object Broker technology to allow access to it's functions from remote heterogeneous systems. The DVN Network Engine is responsible for creating, maintaining and tracking Network IDs and Sub Network IDs.

The DVN Email Delivery Engine 5 is responsible for originating requests for new email networks, delivering those networks via online 12 or batch processes 10, and for using a process for formatting emails to be consistent and useable through all known Internet based email systems. The entire DVN System is configured and managed via a set of Network Management Applications 8.

Web Window applications (Web Windows) 1 can be created to send real-time information in an email. These applications 1 communicate with the DVN Application API 3 to obtain network session, network variables and security information before displaying information. Embedded interactive components (360-degree components) 2 can be custom built or obtained from a library of tools and embedded in the network email. These components 2 also obtain network session, network variables and security information before collecting recipient information. Components 2 and Web Windows 1 register in the Web Window/Component Registry to become visible to the system.

Each time a Web Window Application 1 or 360-degree component 2 is executed, information collected from this use is optionally collected and written to a data collection database. Common shared objects in the Web Window Application 1 can be stored and retrieved from the component-shared database 14.

Network emails constructed within email compilation authoring tools 6 contain embedded Web Windows 1 and/or 360-degree components 2. These emails pass through the DVN Email Delivery Engine 5 before being delivered to allow compatibility between all known Internet based email systems. After being formatted, each email is registered with the DVN Network Engine 4 signaling the email has been sent.

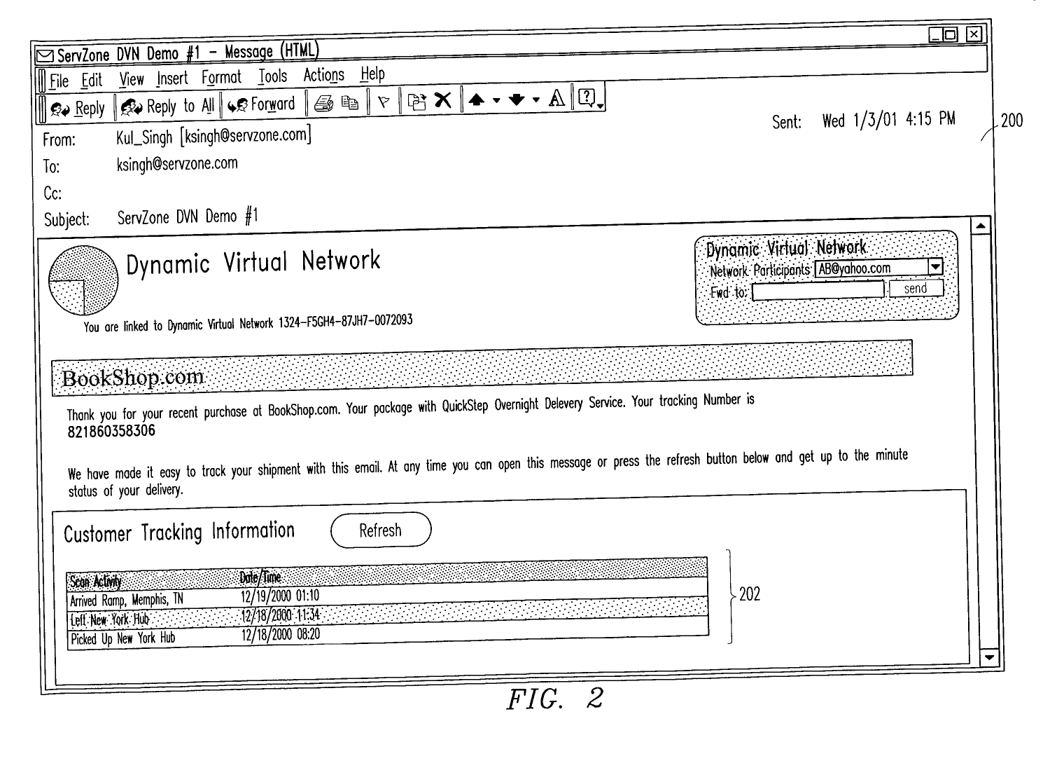

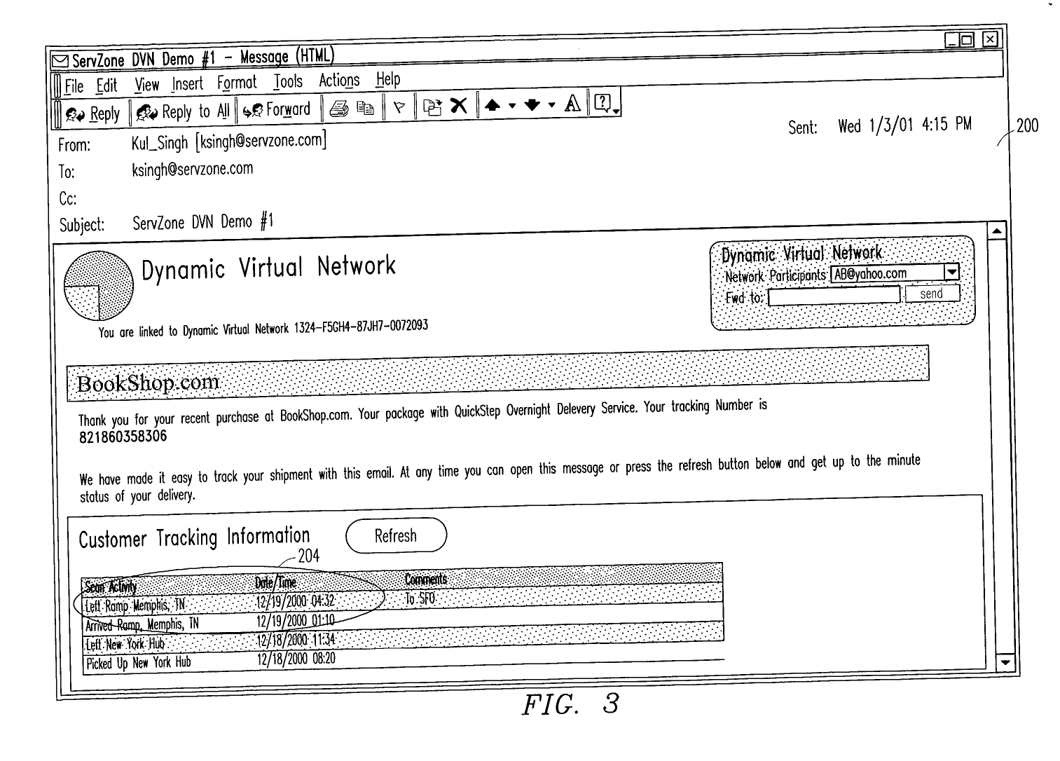

FIGS. 2 and 3 illustrate the network email system 100 accessing the Internet directly without the requirement of a Web browser, showing how an exemplary email 200 can be dynamic and reflecting changing content. Specifically, these diagrams illustrate an example of how the technology may work for an online retailer in providing real-time updates for overnight delivery tracking. When the recipient opens the network email 200, as shown in FIG. 2, the email 200 contains the most recent delivery data 202. FIG. 3 illustrates that the recipient either re-opened the same email 200 or refreshed the email 200 at a later time, where the network email contains the most updated tracking information 204. The tracking application is linked to and transmitted from the company's private network.

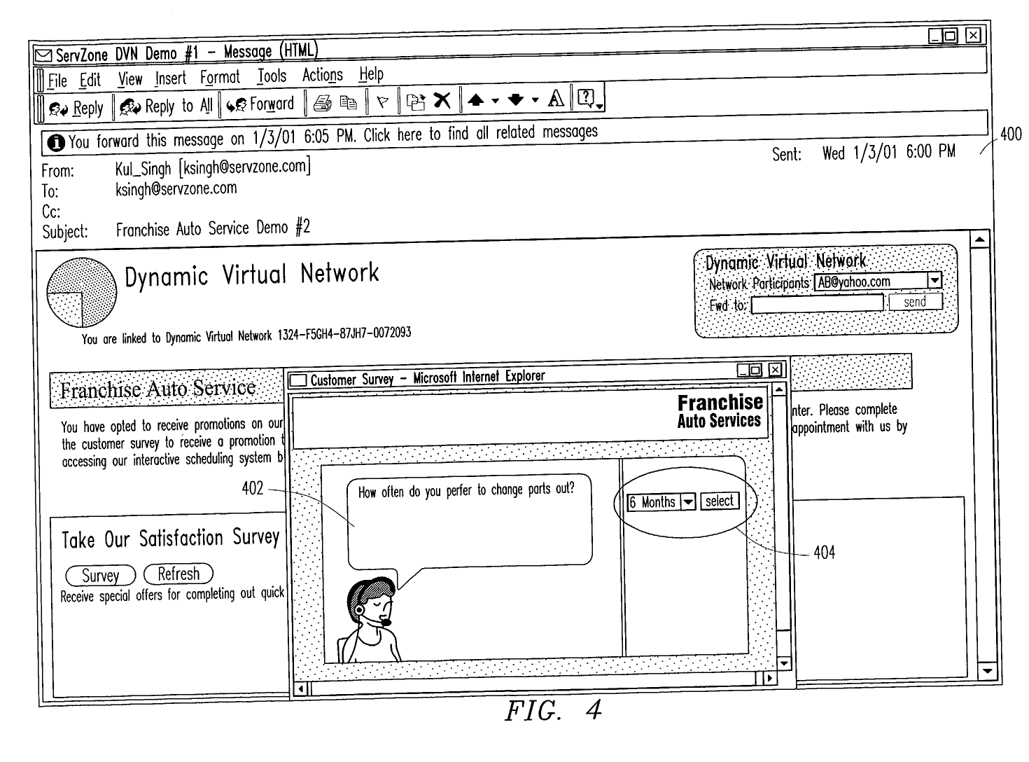

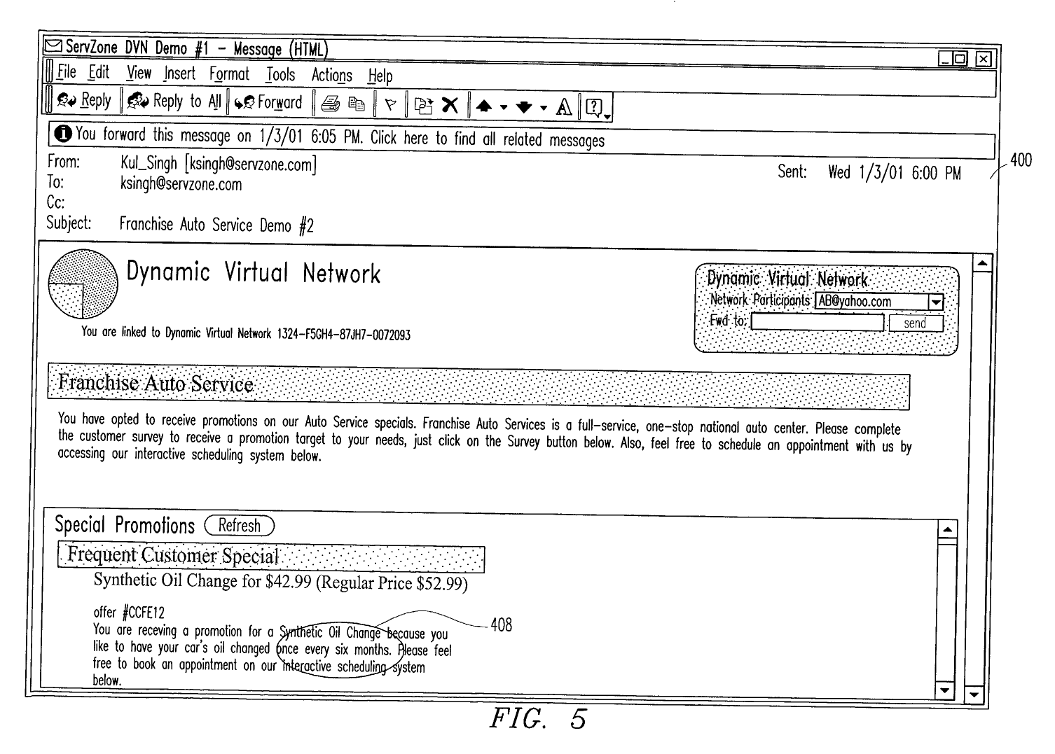

FIGS. 4 and 5 illustrate the exemplary system operating in a mode for allowing users to make inputs into the network email, where the body of the email message 400 changes depending upon the inputs. Specifically, these diagrams illustrate an example of how the technology would work for a company that provides auto services. In this example, the recipient takes a survey within the network email and one question 402 is how often does the recipient prefer to change the oil in their vehicle. In this case, the recipient selects 6 months 406 and the email automatically provides a promotion for oil changes 408 that are only necessary every 6 months. The sender can change the promotion 408 at anytime from their internal network. Thus, the promotion actually resides on the sender's network 100 as opposed to within the email.

In addition to the functions described above, the present invention can enable video and audio to be streamed directly to the email on a real-time basis. The video or audio that is streamed to the email can be modified at anytime by the email originator with different content. Embodiments of the present invention can also provide a way for a previously opened email in a user's email inbox to change to reflect the email has new content whenever new data is updated in the email. Embodiments can also incorporate customer relationship applications such as Instant Messaging so that anyone can communicate in real-time by sending an email with an embedded Instant Messaging application. The present invention can also provide tools so that email originators can freely embed windows anywhere within a body of the email text message such that the window accesses specific real-time information from the Internet. The present invention can also provide workflow solutions where different recipients can view real-time information at the same time or each can have entitlement to view different components of the email. The present invention can also allow real-time document collaboration from within the email.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claim(s).

What is claimed is:

1. A method of emailing comprising:
creating a network ID for an email originator and each email recipient;
assigning a sub-network ID that uniquely identifies each email recipient;
creating, using said network ID and said sub-network IDs, an email network for said email originator and said email recipients; and
providing server-side executables for allowing said email network to access the Internet such that an email recipient can access the Internet directly from within an email and for refreshing information in said email after said email is sent from said email originator.

2. The method of emailing of claim 1, further comprising refreshing said email after being sent from one of said email recipients.

3. The method of emailing of claim 2, wherein said refreshing occurs each time the email is opened.

4. The method of emailing of claim 2, wherein said refreshing occurs when said email is refreshed.

5. An email server architecture for sending and receiving email that are updateable after being sent comprising:
an email application interface (API) that is adapted to interface with a server side executed email application in order to enable the email application to function within a predetermined network;
a network email engine, in communication with said email API, for creating, maintaining and tracking a plurality of network IDs and sub-network IDs; and
an email delivery engine for originating requests for new email networks and for formatting emails for use with an Internet based email system, said email delivery system adapted for being in communication with said server side executed email application;
said email API further adapted to communicate with said server side executed email application order to send or receive real-time information to a previously sent email within said predetermined network having a particular network ID and sub-network ID via said email delivery engine in order to update information in said previously sent email.

6. The email server architecture of claim 5, wherein a sent or received updateable email passes through said email delivery engine in order to make said sent or received updateable email compatible with substantially most internet based email systems.

7. The email server architecture of claim 5, wherein said email delivery engine makes said sent or received updateable email compatible with substantially all internet based email systems.

8. The email server architecture of claim 5, further comprising:
a component data base, in communication with said network email engine, for storing shared objects for use by said email API such that each time said server side executed email application is executed, information collected from said executed application is written to said component data base for usage in updating said previously sent email.

9. An email system comprising:
means for sending an email from an origination to a destination, said email comprising a network ID, a sub-network ID and refreshable data; and
means for refreshing said refreshable data after said email is sent.

10. The email system of claim 9, wherein said means for sending an email comprises:
a server side executed application accessed from email;
a delivery engine, in communication with said server side executed application, for delivering said email and for delivering said refreshable data.

11. The email system of claim 9, wherein said email is sent to a plurality of destinations, each said plurality of destinations having a different sub-network ID.

12. The email delivery system of claim 11, wherein said means for sending an email creates a network among said plurality of destinations and said origination.

13. A method of sending an updateable email comprising:
Sending email from an origination to a destination, each said email comprising a network ID, a different sub-network ID and refreshable data, and
Refreshing said refreshable data after said email is sent.
